(19) United States
(12) Patent Application Publication
(10) Pub. No.: US 2012/0211376 A1
(43) Pub. Date: Aug. 23, 2012

(54) HYDROGEN STORAGE APPARATUS

(75) Inventors: Chih-Ang CHUNG, Jhongli City (TW); Sheng-Long LEE, Jhongli City (TW); Chih-Kuang LIN, Jhongli City (TW); Bo-Yu CHIOU, Jhongli City (TW)

(73) Assignee: National Central University, Jhongli City (TW)

(21) Appl. No.: 13/081,399

(22) Filed: Apr. 6, 2011

(30) Foreign Application Priority Data
Feb. 18, 2011 (TW) 100105443

(51) Int. Cl. F17C 11/00

(52) U.S. Cl. 206/7

(57) ABSTRACT

A hydrogen storage apparatus includes a canister, a first filter element and at least one hydrogen storage unit. The canister has an opening and a rod. The first filter element is disposed in the opening. The hydrogen storage unit is accommodated in the canister. The hydrogen storage unit includes a compartment structure and a hydrogen channel element. The compartment structure divides a space inside the canister, and the hydrogen channel element is pierced by the rod and connected with the compartment structure. The hydrogen channel element includes a plurality of axial channels and a plurality of radial channels. The axial channels are connected with the opening and the radial channels. The radial channels are connected with the space inside the canister.

### CROSS REFERENCE TO RELATED APPLICATIONS

This Non-provisional application claims priority under 35 U.S.C. §119(a) on Patent Application No(s). 100105443 filed in Taiwan, Republic of China on Feb. 18, 2011, the entire contents of which are hereby incorporated by reference.

### BACKGROUND OF THE INVENTION

1. Field of Invention

The invention relates to an air storage apparatus and, in particular, to a hydrogen storage apparatus.

2. Related Art

Recently, hydrogen has been widely applied to the industrial manufacturing processes, and the specifications in the fields of manufacturing, storage, transportation and application thereof have been gradually specified perfectly. The current hydrogen storage technology mainly includes the liquefied hydrogen storage, the high-pressure hydrogen storage, the metal hydride hydrogen storage, the alloy hydrogen storage, and the like. However, when the hydrogen is stored either in a low-temperature liquid state or a high-pressure gaseous state, a lot of energy has to be consumed to liquefy or compress the hydrogen. In addition, the excellent low-temperature insulating device or the specific thick and heavy high-pressure bottle has to be provided to serve as the storage container. Thus, the costs for these two hydrogen storage apparatuses are very high.

The metal hydride and alloy hydrogen storage methods are developed based on the properties of the materials of reversibly absorbing and releasing the hydrogen and thus have the following advantages. The hydrogen storage density is high, the high-pressure container or the insulating device is not needed, the security is high, the doubt of explosion is absent, and the highly-pure hydrogen can be obtained. So, the metal hydride and alloy hydrogen storage methods have gradually become the important direction of research in the current hydrogen storage technology. The hydrogen storage apparatus using the above-mentioned hydrogen storage material will be described in the following.

FIG. 1 is a schematically cross-sectional view showing a hydrogen storage apparatus 1 for storing a hydrogen storage material. Referring to FIG. 1, the conventional hydrogen storage apparatus 1 includes a canister 11, a filter rod 12 and a flow tube 13. A hydrogen storage material M is accommodated in the canister 11. A top of the canister 11 has an opening 111 and a connector 112. One end of the connector 112 is connected with the filter rod 12. The filter rod 12 is made of stainless steel powder by way of sintering. So, the surface of the filter rod 12 has many pores, which cannot be recognized by the naked eyes and can filter the impurity and only allow the hydrogen to pass through the filter rod 12. Two opening ends 131 and 132 of the flow tube 13 respectively penetrate through the canister 11 and are connected with an external heating fluid source and an external cooling fluid source. The portion of the flow tube 13 inside the canister 11 has the double helix structure surrounding the filter rod 12, so that the hydrogen storage material M can proceed with the rapid thermal conduction through the large-area contact between the hydrogen storage material M and the flow tube 13. Thus, the endothermic reaction caused when the hydrogen storage material M releases the hydrogen, or the exothermic reaction caused when the hydrogen storage material M absorbs the hydrogen can be speeded up.

In the conventional hydrogen storage apparatus 1 for storing the hydrogen storage material M, the hydrogen storage material M tends to be broken into small powder after a period of time. Furthermore, the filter rod 12 is formed by sintering the metal powder to form the very dense pores. Thus, the filter rod 12 buried in the hydrogen storage material M tends to be blocked so that the hydrogen flow becomes difficult. If the dimension of the filter pore is too large, the fine powder cannot be effectively filtered out. In addition, the hydrogen storage material M, after being broken into powder, tends to be unevenly accumulated inside the canister 11 of the conventional hydrogen storage apparatus 1, thereby causing different expansion extents of the portions of the hydrogen storage material M in the process of generating the hydrogen, and causing the canister 11 or the flow tube 13 to deform or crack easily. Furthermore, the flow tube 13 of the conventional hydrogen storage apparatus 1 has to be applied and controlled in conjunction with an external device, so that the conventional hydrogen storage apparatus 1 has many restrictions in applications.

Therefore, it is an important subject of the invention to provide a hydrogen storage apparatus capable of making the hydrogen storage material be evenly distributed and preventing the hydrogen storage material from accumulation.

### SUMMARY OF THE INVENTION

In view of the foregoing, an objective of the invention is to provide a hydrogen storage apparatus capable of making the hydrogen storage material be evenly distributed and preventing the hydrogen storage material from accumulation.

To achieve the above objective, the invention discloses a hydrogen storage apparatus including a canister, a first filter element and at least one hydrogen storage unit. The canister has an opening and a rod, and the first filter element is disposed in the opening. The hydrogen storage unit is accommodated in the canister and includes a compartment structure and a hydrogen channel element. The compartment structure divides the space inside the canister. The hydrogen channel element is pierced by the rod and connected with the compartment structure. The hydrogen channel element includes a plurality of axial channels and a plurality of radial channels. The axial channels are connected with the opening and the radial channels, and the radial channels are connected with the space inside the canister.

In one embodiment of the invention, the canister is a cylindrical canister.

In one embodiment of the invention, the canister further includes a sealing cover having the opening.

In one embodiment of the invention, a pore of the first filter element ranges from 0.1 to 1 micron.

In one embodiment of the invention, when there are a plurality of the hydrogen storage units, the hydrogen storage units are stacked and pierced by the rod.

In one embodiment of the invention, the hydrogen storage apparatus further includes a plurality of second filter elements disposed on interfaces between the radial channels of the hydrogen channel element and the space inside the canister. Preferably, the pores of the second filter elements range from 1 to 5 microns.

In one embodiment of the invention, the compartment structure further includes an axial compartment member having a through hole in alignment with the rod and the axial channels, and the axial compartment member is substantially perpendicular to a longitudinal direction of the canister.

In one embodiment of the invention, an inner surface of the canister further has at least one groove engaging with the axial compartment member.

In one embodiment of the invention, the hydrogen storage apparatus further includes at least one buckle, wherein an inner surface of the canister further has at least one groove, and the buckle is mounted around the periphery of the axial compartment member and is engaged with the groove.

In one embodiment of the invention, the compartment structure further includes a plurality of radial compartment members, and the radial compartment members are connected with the hydrogen channel element and are arranged radially.

In one embodiment of the invention, the rod disposed on an axis of the canister is a hollow rod, and a heat transferring device may be installed inside the hollow rod.

As mentioned above, the hydrogen storage apparatus according to the invention provides independent axial and radial gas flowing channels through the hydrogen channel element of the hydrogen storage unit, and utilizes the compartment structure to divide the space inside the canister into many small compartments for accommodating the hydrogen storage material, so that the hydrogen storage apparatus of the invention can ease the phenomenon that the hydrogen storage material is accumulated. In this embodiment, the stack of the hydrogen storage units is advantageous to the adjustment of the capacity of the hydrogen storage apparatus according to the actual product requirement. Compared with the prior art, the hydrogen can be smoothly delivered in the canister of the hydrogen storage apparatus of the invention, and the phenomenon that the hydrogen storage material is accumulated can be eased. Thus, it is possible to prevent the hydrogen storage apparatus from the dangers of deformation and crack caused by the uneven expansion of the hydrogen storage material in absorbing the hydrogen. In addition, the compartment structure with the high heat transfer rate can speed up the heat transfer inside/outside the canister, and can effectively increase the rate of the hydrogen storage apparatus for absorbing the hydrogen. On the other hand, the hydrogen storage apparatus can be easily installed and does not need the application and the control of the external device. These properties further expand the application range of the hydrogen storage apparatus.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematically cross-sectional view showing a conventional hydrogen storage apparatus for storing a hydrogen storage material;

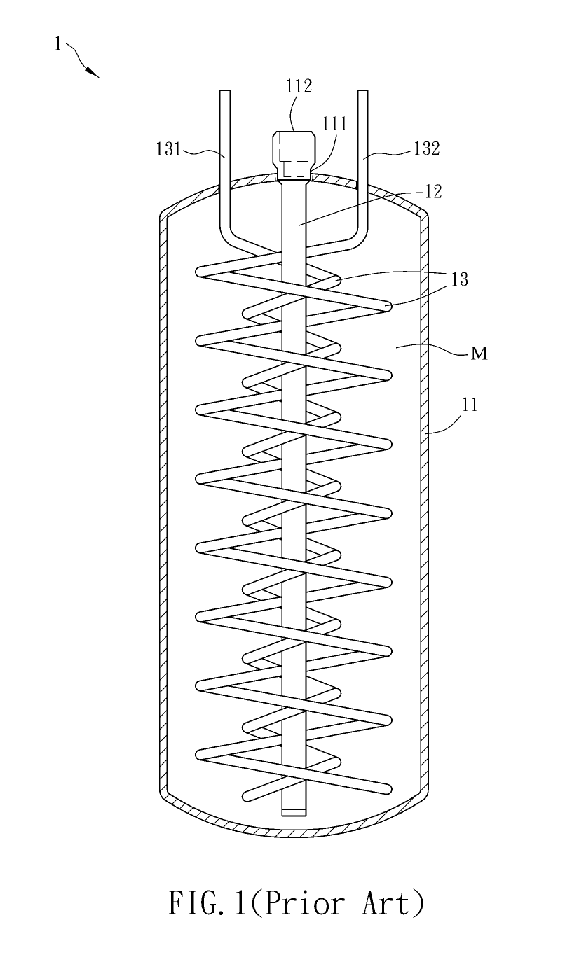

FIG. 2 is a schematically decomposed illustration showing a hydrogen storage apparatus according to a first embodiment of the invention;

FIG. 3A is a schematic illustration showing a hydrogen storage unit according to FIG. 2;

FIG. 3B is a schematically decomposed illustration showing the hydrogen storage unit according to FIG. 2;

FIG. 4 is a cross-sectional view showing a hydrogen channel element in the hydrogen storage unit according to FIG. 2;

FIG. 5 is a schematically cross-sectional view showing a canister of the hydrogen storage apparatus according to another aspect of the invention;

FIG. 6 is a schematically decomposed illustration showing a hydrogen storage unit of the hydrogen storage apparatus according to another aspect of the invention; and

FIG. 7 is a schematically decomposed illustration showing a hydrogen channel element and second filter elements of the hydrogen storage apparatus according to the invention.

### DETAILED DESCRIPTION OF THE INVENTION

The present invention will be apparent from the following detailed description, which proceeds with reference to the accompanying drawings, wherein the same references relate to the same elements.

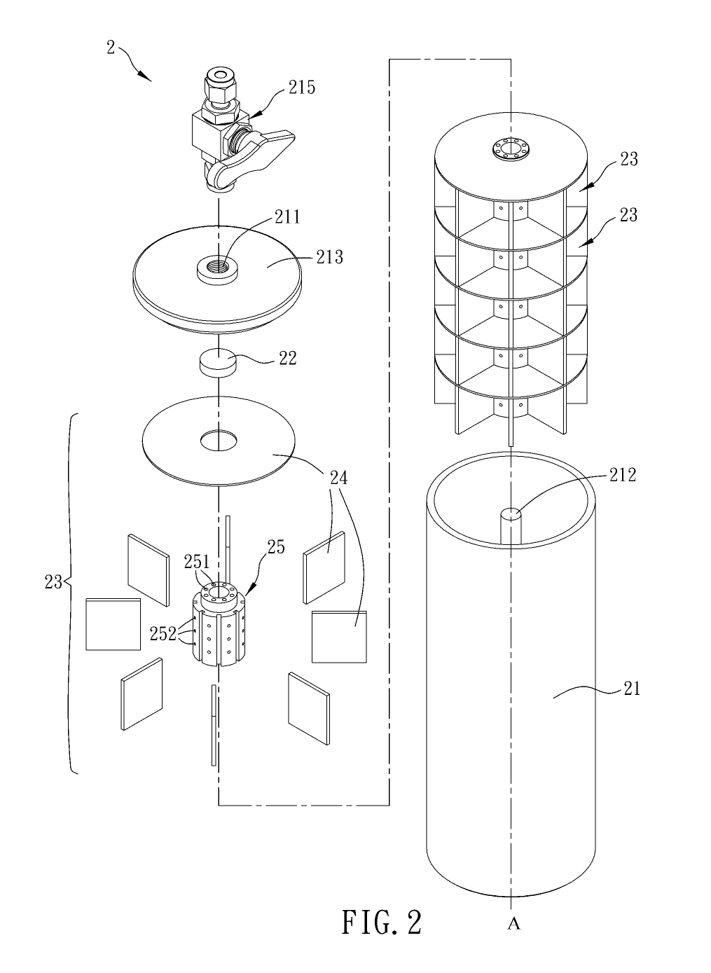

FIG. 2 is a schematically decomposed illustration showing a hydrogen storage apparatus 2 according to a first embodiment of the invention. Referring to FIG. 2, the hydrogen storage apparatus 2 includes a canister 21, a first filter element 22 and at least one hydrogen storage unit 23. The hydrogen storage apparatus 2 may be loaded with a substance (also referred to as a hydrogen storage material) capable of absorbing or desorbing the hydrogen. The substance may be in the form of powder or colloid, and is not particularly restricted.

The canister 21 has an opening 211 and a rod 212. In this embodiment, the canister 21 is a cylindrical canister. However, the canister 21 may be one of a polyhedron, a sphere, an irregular body and a combination thereof according to the actual application. Furthermore, the hydrogen storage apparatus 2 is a pressure container, and the canister 21 may further include a sealing cover 213 for sealing the canister 21, so that the internal pressure of the canister 21, and thus the hydrogen supplying pressure, may be adjusted according to the usage properties of different hydrogen storage materials, and the better hydrogen storage effect can be obtained. The sealing cover 213 has the above-mentioned opening 211, which may be controlled by, without limitation to, a valve 215 for controlling the gas to flow in and out through the opening 211 and preventing the leakage of the gas. In addition, the rod 212 of the canister 21 is disposed in a space inside the canister 21. The rod 212 is preferably a hollow rod, and the rod 212 is disposed on an axis A of the canister 21 so that the hydrogen storage unit 23 can be fixed and pierced by the rod 212. To be noted, a heat transferring device, such as a heat pipe or flow tube, can be installed inside the hollow rod. This configuration can enhance the heat transfer efficiency in the hydrogen storage apparatus.

The first filter element 22 is disposed in the opening 211 of the canister 21, and filters the gas flowing into/out of the canister 21. The pores of the first filter element 22 preferably range from 0.1 to 1 micron, and the size of the pore may be adjusted according to the particle diameter of the powder of the hydrogen storage material, which is actually produced, so that the pores of the first filter element 22 are slightly smaller than the minimum particle diameter of the hydrogen storage material or the minimum particle diameter of the powder, produced after the hydrogen storage material is broken. Thus, only the hydrogen released from the hydrogen storage material in the canister 21 can pass through the opening 211, and the fine powder inside the canister 21 cannot be dissipated from the canister 21 with the opening of the opening 211.

The hydrogen storage unit 23 accommodated in the canister 21 includes a compartment structure 24 and a hydrogen channel element 25. The compartment structure 24 divides a space inside the canister 21. The hydrogen channel element 25 is substantially cylindrical, is pierced by the rod 212, and is connected with the compartment structure 24. The hydrogen channel element 25 includes a plurality of axial channels 251 and a plurality of radial channels 252. The axial channels 251 are connected to the opening 211 and the radial channels 252. The radial channels 252 are connected to the space inside of the canister 21. The hydrogen storage unit 23 accommodates the material that can store the hydrogen, such as the hydrogen storage alloy, metal hydride, composite hydride or the like. The compartment structure 24 evenly divides the hydrogen storage material to prevent the hydrogen storage material from being unevenly accumulated due to the gas flow caused when the hydrogen is being absorbed or released, and thus to prevent the deformation or crack of the canister 21 caused after the expansion of the hydrogen storage material. In the preferred embodiment, the material of the compartment structure 24 may be the metal with the high heat transfer rate and the high rigidity, and the compartment structure 24 is connected with the canister 21, so as to conduct the heat of the hydrogen storage material to/from the outside of the canister 21 rapidly, and thus to speed up the hydrogen absorbing/releasing rate of the hydrogen storage apparatus 2.

As shown in FIG. 2, when there are multiple sets of hydrogen storage units 23, the hydrogen storage units 23 are stacked, pierced by the rod 212 and accommodated in the canister 21. In the example of FIG. 2, the hydrogen storage apparatus 2 includes six hydrogen storage units 23. In practice, however, the number of the hydrogen storage units 23 of the hydrogen storage apparatus 2 can be modified according to the accommodating space or the required hydrogen storage capacity. Of course, only one single hydrogen storage unit 23 can be provided, and the size of the canister 21 may also be modified according to the number of the hydrogen storage units 23 to just accommodate all the hydrogen storage units 23. When the hydrogen storage apparatus 2 is being installed, one hydrogen storage unit 23 may be provided to divide the compartment structure 24 into small compartments, in which the hydrogen storage material is evenly placed. Then, other hydrogen storage units 23 may be stacked upwards, so that the assembling method is quite simple and can be easily implemented.

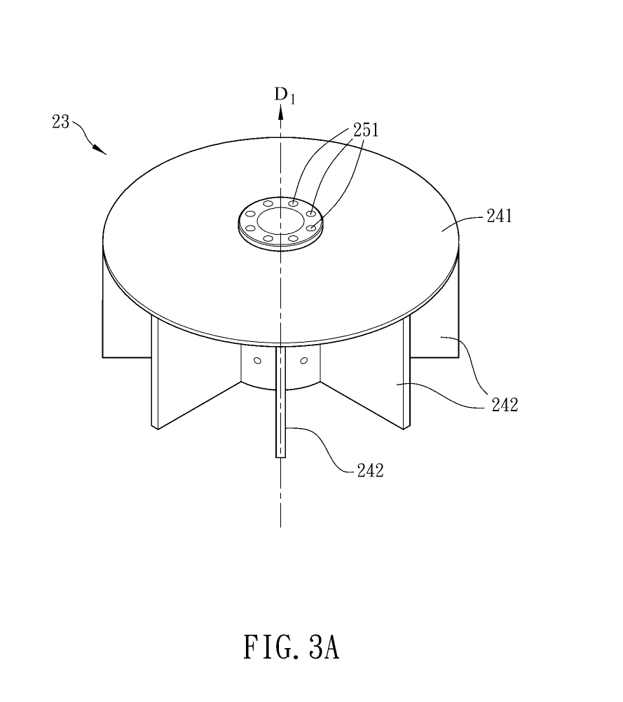

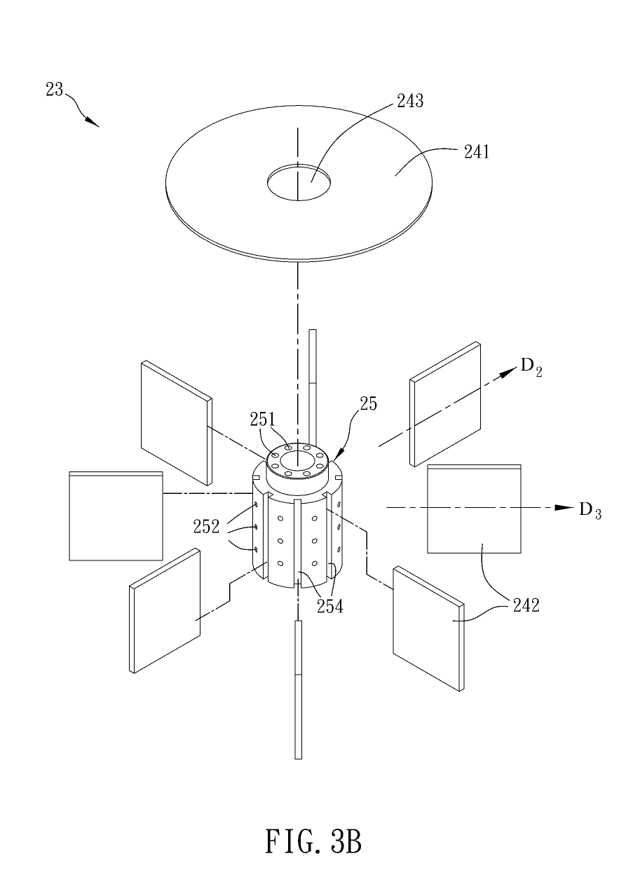

Please refer to FIGS. 2, 3A and 3B. FIG. 3A is a schematic illustration showing the hydrogen storage unit according to FIG. 2. FIG. 3B is a schematically decomposed illustration showing the hydrogen storage unit according to FIG. 2. The compartment structure 24 in the hydrogen storage unit 23 may further include an axial compartment member 241 and a plurality of radial compartment members 242. It is to be specified that “axial” represents a longitudinal axis of the canister 21. Thus, the axial compartment member 241 divides the space inside the canister 21 along a longitudinal direction D₁. In addition, “radial” represents an arbitrary direction perpendicular to the longitudinal axis of the canister 21. Thus, the radial compartment members 242 are disposed along different radius directions (e.g., the radius directions D₂ and D₃ of FIG. 3B) to divide the space inside the canister 21. In this embodiment, the axial compartment member 241 has a through hole 243 in alignment with the rod 212, and is connected with the hydrogen channel element 25 using the through hole 243. The axial compartment member 241 is substantially perpendicular to the longitudinal axis of the canister 21, and the periphery of the axial compartment member 241 is preferably attached to the inner surface of the canister 21 to prevent the hydrogen storage material from leaking from the hydrogen storage unit 23. In this embodiment, the longitudinal axis and the axis A of the canister 21 of FIG. 2 have the same direction. Of course, the direction of the longitudinal axis may also be different from the direction of the axis A. The aspects do not intend to restrict the scope of the invention. One end of the radial compartment member 242 is connected to the side surface of the hydrogen channel element 25 parallel with the longitudinal axis, and is arranged radially along the radius direction with the hydrogen channel element 25 serving as a center. The other end of the radial compartment member 242 is preferably attached to the inner surface of the canister 21 to prevent the hydrogen storage material from moving in the adjacent compartments, divided by the radial compartment member 242.

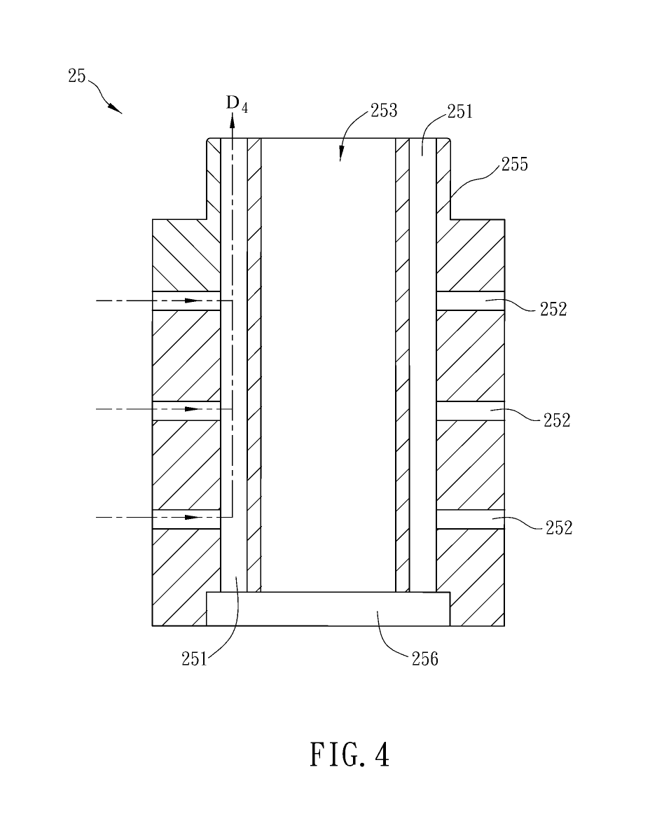

Please refer to FIGS. 2, 3B and 4. FIG. 4 is a cross-sectional view showing a hydrogen channel element in the hydrogen storage unit according to FIG. 2. The hydrogen channel element 25 is a hydrogen flowing conduit when the hydrogen storage apparatus 2 is absorbing/releasing the hydrogen. In order to make the hydrogen storage unit 23 be pierced by the rod 212, the hydrogen channel element 25 has a hollow structure 253 to be pierced by the rod 212. In addition, in order to enhance the connection between the compartment structure 24 and the hydrogen channel element 25 and the connection stability between the hydrogen storage units 23, the hydrogen channel element 25 may further have a plurality of grooves 254, a convex portion 255 and a concave portion 256. The grooves 254 are mounted around the external surface of the hydrogen channel element 25 parallel to the longitudinal axis and engaged with the radial compartment member 242. The convex portion 255 and the concave portion 256 are disposed on two axial ends of the hydrogen channel element 25. When there are plural hydrogen storage units 23 disposed in a stacked manner, the convex portion 255 of one of the hydrogen storage units 23 upwardly pierces the through hole 243 of the axial compartment member 241 and is then inserted into the concave portion 256 of another hydrogen storage unit 23 to complete the connection between two hydrogen storage units 23. In this manner, the other hydrogen storage units 23 can continue to upwardly pierce still another or more hydrogen storage units 23. The convex portion 255 of the last hydrogen storage unit 23 rests against the first filter element 22 in the opening 211 to form the firm structure of the hydrogen storage unit 23.

Referring again to FIGS. 2 and 4. The flow direction of the hydrogen in the hydrogen channel element 25 will be described in the following example regarding the hydrogen releasing process of the hydrogen storage material after the hydrogen storage apparatus is filled with the hydrogen storage material to become a hydrogen fuel battery. As indicated by the gas flow direction D₄ of FIG. 4, the hydrogen released from the hydrogen storage material flows toward the radial channel 252 of the hydrogen channel element 25 through the space inside the canister 21. Next, the hydrogen inside the radial channels 252 is converged to the axial channel 251, then the hydrogen flows to the opening 211 of the canister 21 from the axial channels 251, and finally the hydrogen is released out of the canister 21 after the first filter element 22 filters the impurity. With the axial channels 251 and the radial channels 252, the hydrogen, released from the hydrogen storage material, can directly firstly enter the radially disposed radial channels 251 and then be converged to the axial channels 252 so that the hydrogen can flow out of the hydrogen storage apparatus 2.

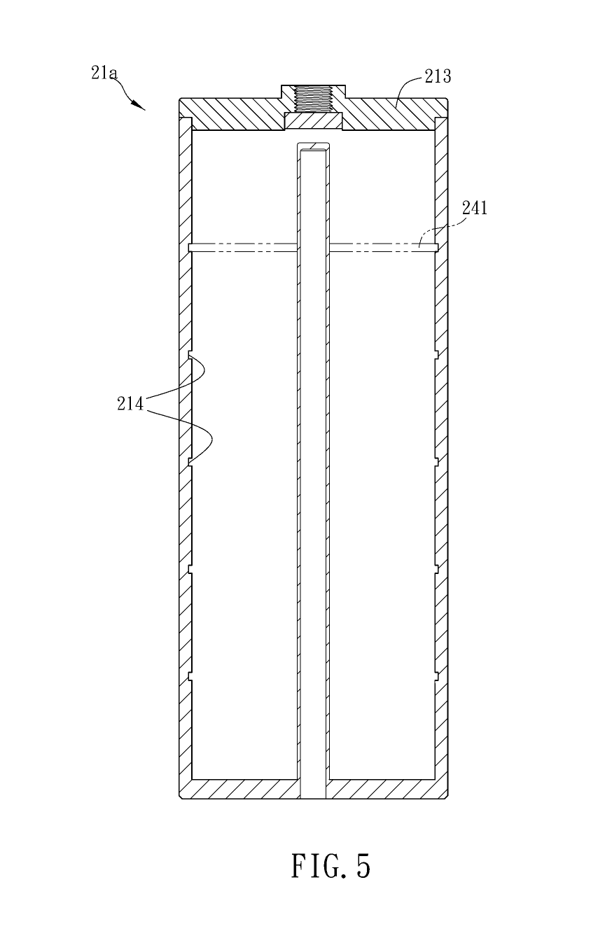

FIG. 5 is a schematically cross-sectional view showing a canister 21a of the hydrogen storage apparatus according to another aspect of the invention. The canister 21a and the canister 21 in the embodiment of FIG. 3B have substantially the same structures except that the inner surface of the canister 21a further has at least one groove 214 for engaging with the periphery of the axial compartment member 241 (depicted in dashed lines), so that the hydrogen storage unit (not completely shown) may be fixed to the canister 21a more firmly. The groove 214 is disposed on the inner surface of the canister 21a for 360 degrees. For example, if the canister 21a is a cylindrical canister, the groove 214 may be an annular groove, and the number of the groove(s) 214 corresponds to the number of the hydrogen storage unit(s) in the hydrogen storage apparatus. In the example of FIG. 5, the hydrogen storage apparatus includes six hydrogen storage units. Thus, the canister 21a has five grooves 214.

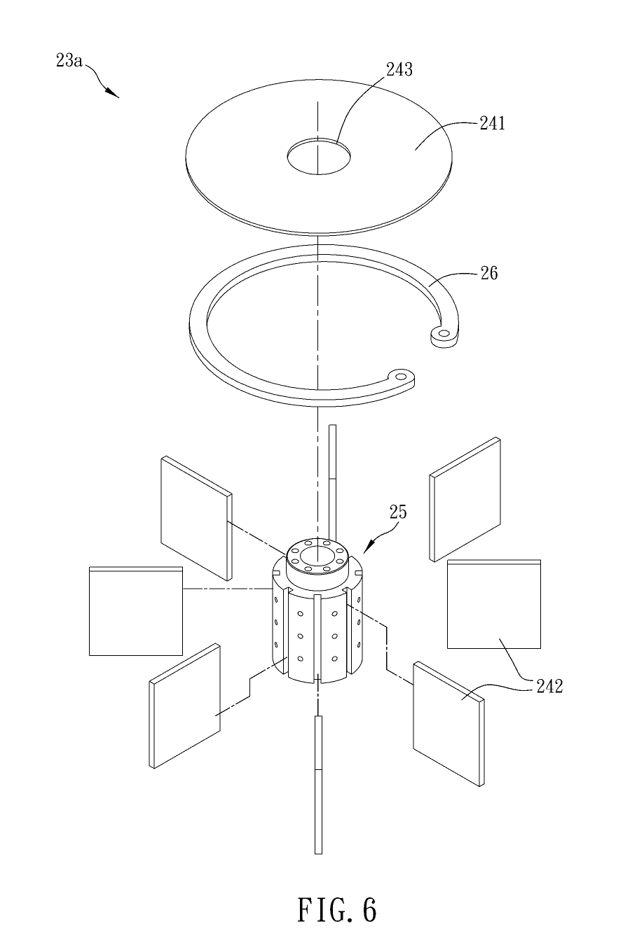

Please refer to FIGS. 5 and 6. FIG. 6 is a schematically decomposed illustration showing a hydrogen storage unit 23a of the hydrogen storage apparatus according to another aspect of the invention. The hydrogen storage unit 23a and the hydrogen storage unit 23 in the embodiment of FIG. 3B have substantially the same structures except that the hydrogen storage unit 23a further includes at least one buckle 26, which is mounted around the periphery of the axial compartment member 241, is engaged with the groove 214 on the inner surface of the canister 21a of FIG. 5, and can further enhance the connection between the hydrogen storage unit 23a and the canister 21a.

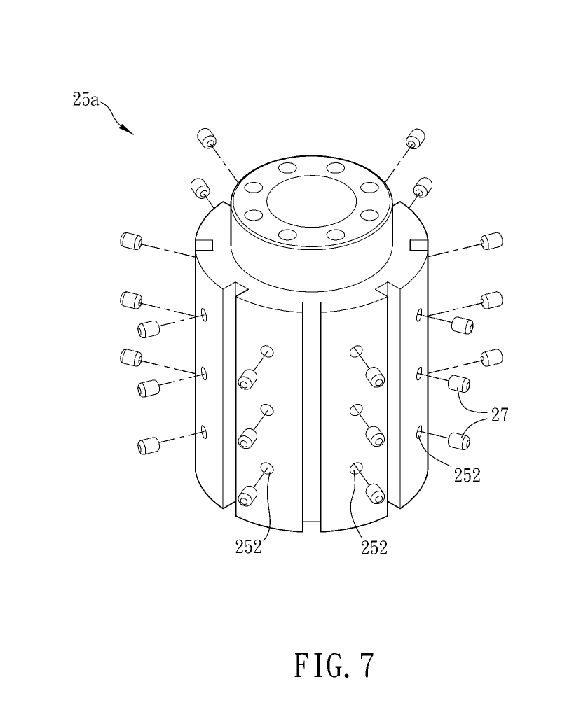

FIG. 7 is a schematically decomposed illustration showing a hydrogen channel element 25a and second filter elements 27 of the hydrogen storage apparatus according to the invention. As shown in FIG. 7, the hydrogen channel element 25a of this embodiment and the hydrogen channel element 25 of FIG. 3B have substantially the same structures except that the hydrogen storage apparatus of FIG. 7 further includes a plurality of second filter elements 27 disposed on the interface between the radial channels 252 of the hydrogen channel element 25a and the space inside the canister. Thus, the number of the second filter elements 27 is the same as the number of the radial channels 252. Preferably, the pores of the second filter elements 27 may range from 1 to 5 microns. The pore size of the second filter element 27 is configured to be adjusted in correspondence with the aperture size of the first filter element (e.g., the element 22 of FIG. 2). The second filter elements 27 firstly filter most of the particles of the hydrogen storage material carried by the hydrogen gas flow, and then the first filter element (e.g., the element 22 of FIG. 2) in the opening filters out the finely powdered hydrogen storage material. Thus, the hydrogen storage apparatus of this embodiment can effectively filter out the fine powder carried by the hydrogen, and can prevent the powder from blocking the pore of the filter element with the too small size, wherein the blocked pores increase the flowing impedance of the hydrogen.

In summary, the hydrogen storage apparatus according to the invention provides independent axial and radial gas flowing channels through the hydrogen channel element of the hydrogen storage unit, and utilizes the compartment structure to divide the space inside the canister into many small compartments for accommodating the hydrogen storage material, so that the hydrogen storage apparatus of the invention can ease the phenomenon that the hydrogen storage material is accumulated. In this embodiment, the stack of the hydrogen storage units is advantageous to the adjustment of the capacity of the hydrogen storage apparatus according to the actual product requirement. Compared with the prior art, the hydrogen can be smoothly delivered in the canister of the hydrogen storage apparatus of the invention, and the phenomenon that the hydrogen storage material is accumulated can be eased. Thus, it is possible to prevent the hydrogen storage apparatus from the dangers of deformation and crack caused by the uneven expansion of the hydrogen storage material in absorbing the hydrogen. In addition, the compartment structure with the high heat transfer rate can speed up the heat transfer inside/outside the canister, and can effectively increase the rate of the hydrogen storage apparatus for absorbing the hydrogen. On the other hand, the hydrogen storage apparatus can be easily installed and does not need the application and the control of the external device. These properties further expand the application range of the hydrogen storage apparatus.

In addition, if the hydrogen channel element and the first filter element are further used in conjunction with the second filter elements, the fine powder carried by the hydrogen can be effectively filtered out, so that the hydrogen storage apparatus, when releasing the hydrogen, has the good hydrogen cleanness, and the powder of the hydrogen storage material cannot block the pores of the filter elements and block the delivery of the hydrogen. In addition, the hydrogen storage unit and the structure of the canister are cleverly designed so that the hydrogen storage unit of the hydrogen storage apparatus of the invention can be fixed in the canister more firmly, and the security of the hydrogen storage apparatus is also enhanced therewith.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A hydrogen storage apparatus, comprising:
a canister having an opening and a rod;
a first filter element disposed in the opening; and
at least one hydrogen storage unit, which is accommodated in the canister and comprises:
a compartment structure dividing a space inside the canister, and
a hydrogen channel element, which is pierced by the rod and connected with the compartment structure, and comprises a plurality of axial channels and a plurality of radial channels, wherein the axial channels are connected with the opening and the radial channels, and the radial channels are connected with the space inside the canister.

2. The hydrogen storage apparatus according to claim 1, wherein the canister is a cylindrical canister.

3. The hydrogen storage apparatus according to claim 1, wherein the canister further comprises a sealing cover having the opening.

4. The hydrogen storage apparatus according to claim 1, wherein a pore of the first filter element ranges from 0.1 to 1 micron.

5. The hydrogen storage apparatus according to claim 1, wherein when there are a plurality of the hydrogen storage units, the hydrogen storage units are stacked and pierced by the rod.

6. The hydrogen storage apparatus according to claim 1, further comprising:
a plurality of second filter elements disposed on interfaces between the radial channels of the hydrogen channel element and the space inside the canister.

7. The hydrogen storage apparatus according to claim 6, wherein pores of the second filter elements range from 1 to 5 microns.

8. The hydrogen storage apparatus according to claim 1, wherein the compartment structure further comprises an axial compartment member having a through hole in alignment with the rod and the axial channels, and the axial compartment member is substantially perpendicular to a longitudinal direction of the canister.

9. The hydrogen storage apparatus according to claim 8, wherein an inner surface of the canister further has at least one groove engaging with the axial compartment member.

10. The hydrogen storage apparatus according to claim 8, further comprising:
at least one buckle, wherein an inner surface of the canister further has at least one groove, and the buckle is mounted around a periphery of the axial compartment member and is engaged with the groove.

11. The hydrogen storage apparatus according to claim 1, wherein the compartment structure further comprises a plurality of radial compartment members, and the radial compartment members are connected with the hydrogen channel element and are arranged radially.

12. The hydrogen storage apparatus according to claim 1, wherein the rod disposed on an axis of the canister is a hollow rod, in which a heat transferring device is installed.
